(19) United States
(12) Patent Application Publication
(10) Pub. No.: US 2007/0054251 A1
(43) Pub. Date: Mar. 8, 2007

(54) Method and kit of materials to intercept name-calling and hurtful language in school

(76) Inventor: Laurie Mandel, Miller Place, NY (US)

Correspondence Address: Panagiota Betty Tufariello, Esq.;INTELLECTULAW, THE LAW OFFICES OF, P.B. TUFARIELLO, P.C., 8 Fountain Ave., Selden, NY, 11784, US

(21) Appl. No.: 11/132,890

(22) Filed: Aug. 23, 2005

(51) Int. Cl. G09B 19/00

(52) U.S. Cl. 434/238

(57) ABSTRACT

A Character education method design to address name calling in elementary and middle schools comprising the steps of raising the awareness of adults and children about the language they use, teaching ways to intercept hurtful language and empowering students to stand up and challenge others and the language others use in a kind and respectful fashion.

### CROSS REFERENCE TO RELATED APPLICATIONS

The instant application is a regular application of provisional application No. ______ filed on May 18, 2004 entitled METHOD AND KIT OF MATERIALS TO INTERCEPT NAME-CALLING AND HURTFUL LANGUAGE IN SCHOOL, and for which priority is claimed.

### BACKGROUND OF THE INVENTION

1. Field of the Invention

This invention relates to a method and apparatus for behavioral modification, and more particular relates to an in-school and out-of-school program, including a kit of material, for correcting improper behavior of students towards their peers.

2. Description of the Prior Art

Several prior art devices and methods employing behavior modification programs are disclosed but unrelated to the present invention. For example, patent application Ser. No. 10/248,580 (Publication No. US2003/0108850 A1) to Murgia et al. is a user-interactive behavior modification system for use with the Internet and wireless network to promote desirable user's behavioral patten in daily life. U.S. Pat. No. 5,573,404 to Stawski discloses a behavior modification device and process, which utilizes a chart with a system of allowances for desired behavior.

Other prior art programs disclose a training method for desired behavior, but not in school systems. For example, patent application Ser. No. 10/023,034 (Publication No. US 2002/0110792 A1) to Mastria is a training method for an individual to increase an individual's attention to his or her present environment and awareness of the surroundings. This method is used by individuals in interpersonal relationships and parent/child relationships.

Further, other prior art programs exist as games. For example, U.S. Pat. No. 6,296,487 B1 to Fruge discloses a behavior tracking board, which records and monitors the general behavior of the small children. The game unit utilizes allowance and tab cards redeemed for money or activities. U.S. Pat. No. 5,573,405 to Evans discloses a behavior training and modification device, which includes a board and pegs that represent an individual's task and behaviors. The device is used for encouraging the development of responsibility and character in children.

Similarly, U.S. Pat. No. 6,572,380 B1 to Buckley et al. discloses a game unit and a method for teaching favorable behavioral patterns through an allowance system. Further, U.S. Pat. No. 5,725,381 to Kollath et al, discloses a motivational system for children, which consists of a board, play money, and coupons for predefined rewards. Additionally, U.S. Pat. No. 5,697,790 to Garland discloses a method for teaching discipline between care-giver and child with a system of tokens as rewards.

A prior art related to education, but again unrelated to the present invention, is U.S. Pat. No. 5,741,137 to Aduvala which discloses educational cards for teaching emotional expressions. Specifically, it is a device for assisting young children with recognizing emotions, thoughts and actions in daily life.

The most closely related prior art is patent application Ser. No. 10/222,321 (Publication No. US2003/0036042 A1) to Hill which discloses a method of teaching an individual to program his or her mind to follow a voluntary personal behavior plan that helps to achieve a predetermined goal. A set of rules and techniques are provided so that the individual selects and follows a personal behavior plan. Individuals make a promise to follow the selected behavior plan and reach the predetermined goal.

### SUMMARY OF THE INVENTION

The invention relates to a behavior modification method or process of reducing offensive language in school systems. More specifically, the invention is related to a method for addressing and intercepting name-calling, insults, and hurtful, inappropriate, or offensive language in school. The method functions by beginning with a small group of faculty and students, raising their awareness, and then empowering them to take action. The steps include a core group of interested faculty who take an oath in front of the school organizer following with the signature on the oath. Once having taken the oath, they become a Verbalist in Prevention (VIP). The VIP receives a package of materials, introduces the program to students in their classes, clubs or coaching activities, and administers the oath procedure and signature process. Those who take the oath acknowledge the oath taker. As students take the oath, the number of students who join increases exponentially. The VIP keeps a log or database of participants, which is given to the coordinator. All oaths are collected to create a visual mural to track the profession of the participant. A special assembly is organized for students intrinsically motivated to take the oath, which serves to create a dominant culture in the school in a positive fashion. The method includes a series of power cards, stickers, bookmarks, certificates, and poster designs, which include insult prevention statements or indicia.

### BRIEF DESCRIPTION OF THE DRAWINGS

FIG. 1 is the oath card utilized by each participating student and adult.

FIG. 2 is the power card given to students with ten phrases to counter teasing/bullying.

FIG. 3 is the VIP (Verbalist in Prevention) badge worn by adults who take the oath.

FIG. 4 is the student sticker with empowering slogan.

FIG. 5 is the student certificate given to students who took the oath.

FIG. 6 is the student bookmark with three statements.

FIG. 7 is the laminated card with a slogan that is affixed to the door of classroom or office.

FIG. 8 is a flow chart showing the steps in the method of the present invention for behavioral modification of students which addresses name-calling.

### DETAILED DESCRIPTION OF THE PREFERRED EMBODIMENT

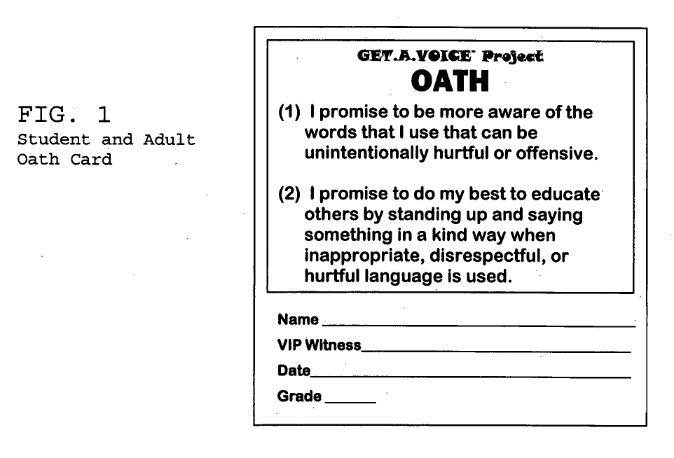

FIG. 1 illustrates the oath card, which is a vehicle to obtain a written and oral commitment on the part of students and adults in the school community to be more aware of their disrespectful, offensive and inappropriate language. The oath card is designed so that each student participant and each adult participant is provided with his/her own card. It is very important that one card is not shared by anyone or that one card is not altered in any way. Each participating individual requires his or her own card that is signed by that person, dated, and then signed by the adult VIP presiding over the oath-taking.

The oath card is approximately 4″×5″ intentionally designed with a font size of about 20 points so that younger elementary through older secondary school students can read it and hold it comfortably.

The two-statement oath card reads, (1) “I promise to be more aware of the words that I use that can be unintentionally hurtful or offensive,” and (2) I promise to do my best to educate others by standing up and saying something in a kind way when inappropriate, disrespectful, or hurtful language is used.

Taking an oath is the premise of the present invention. Many times students will say hurtful comments without thinking about what he/she is saying, and follow up the comment by saying. “I was just kidding” or “I was just joking” or “Can't they take a joke?” The lack of awareness, lack of empathy, and lack of respect inherent in the words and phrases students use toward each other are very blatant in schools. Both adults and students have become desensitized to hurtful, inappropriate, and offensive language under the guise of attitudes and beliefs such as, “Boys will be Boys,” “Girls will be girls,” “That's the way kids are,” and “Let them (students) work it out themselves.”

To prompt students to be more aware of the power of their own words, and to empower students to stand up to other students, the oath card provides the method to challenge students in their own and other's use of language. The philosophy of this invention is that the act of taking the oath leads to a shift in thinking. Thus, this invention is about shifting one's thinking from a thought process that “does not filter language” to a thought process that “does filter language.”

For students taking the oath, an adult is required to be present. This adult has personally taken the oath in the presence of the school coordinator and has the title of VIP (Verbalist in Prevention). The student, in the presence of the VIP, reads the oath out loud, then signs the oath with his/her signature, then the VIP signs it and dates it. The oath then is collected and displayed in a mural in the school hallway.

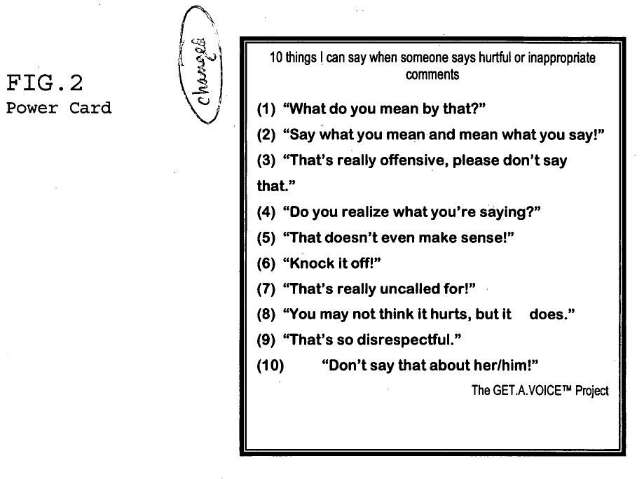

When the student oath is completed, the student is given the power card, sticker, certificate and bookmark respectively shown in FIGS. 2, 4, 5 and 6.

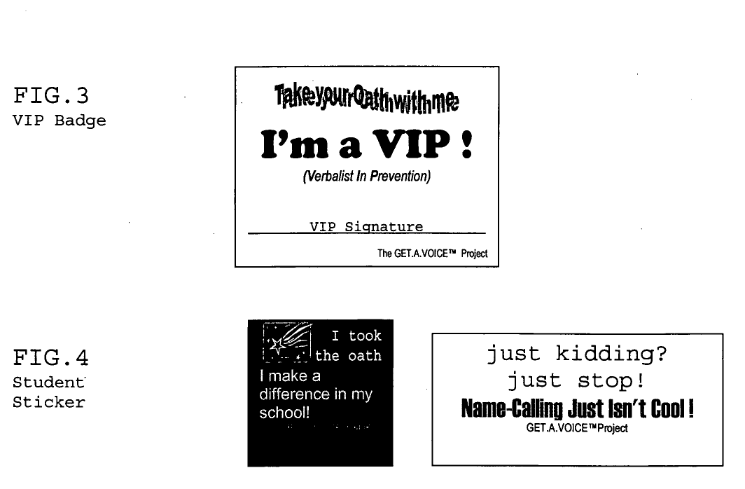

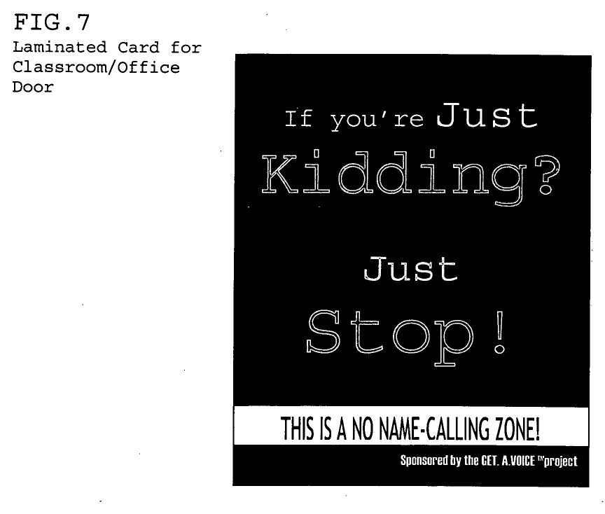

When the adult oath in completed, the adult is given the badge and card respectively shown in FIGS. 3 and 7.

FIG. 2 illustrates the power card, which is a vehicle provided to students to empower them to have words/language to counter hurtful, inappropriate, or offensive language that is said to them directly or said to others in their purview. The power card is a most effective method of this invention because two of the biggest reasons students do not stand up when they hear hurtful, inappropriate, or offensive language is because they do not know what to say at the moment it is being said, and because they do not want to risk not being “cool” by standing up and saying something.

The power card levels the playing field so that students become equipped with ten counter phrases with the same phrases. These is nothing like this that currently exists. Students are largely left to solve verbal interactions on their own, and too often teachers admittedly do not intervene for two reasons: they often do not hear it, or they need to move on quickly to cover content or curriculum material in their class. While some kids are naturally resilient to comments and language, too many students are verbally bullied on a daily basis without ammunition, without strategy, and with much fear.

The power card contains a list often effective one-line phrases. They are specifically one-liners so that students can remember them, recall them, and say them with ease. The heading on top of the card reads, “10 things I can say when I hear hurtful, inappropriate, or offensive language.” It is stated in this way so that students can easily remember that they have a reference tool with statements ready for them when needed. They are effective also in that if a student remembers one or two lines and draws upon those lines in every situation, the power card is just as effective. The language is child-friendly and child-tested.

The size of the card and the card-stock paper it is printed on is specific to this invention. As a reference tool, the 4″×6″ card can be taped inside the flap of a student's notebook or taped to the desk of a student at the elementary school level, and can be folded and placed in a wallet or pocket or inside the locker of a secondary school student who will most likely wish to keep it out of one's view. The cardstock is selected for its durability.

FIG. 3 illustrates the VIP badge, which is given to and worn by adults in the school community (teachers, administrators, librarians, social workers, aids and the like) who have taken the oath. It is a small 2″×3″ badge which reads, “Take your oath with me, I'm a VIP.” It is printed on a bright orange paper and slid into a plastic pin-back name-badge. Adults pin the name-badge to their identification necklaces (usually required in schools).

The badge lets students know three important pieces of information: (a) that the teacher is an adult role model who also took the oath, (b) that the teacher does not tolerate name-calling, or hurtful, inappropriate, and offensive language, and (c) that the student can take the oath with that teacher when he/she is ready to do so. The badge also lets other adults know that their colleague is participating in this program to address name-calling.

FIG. 4 illustrates the stickers provided to students who take the oath. The full-color stickers contain the slogan created specifically for this program, which reads, “Just kidding? Just stop! Name-Calling Just Isn't Cool!” The sticker is approximately 1″×3″ and is colorful, small, and poignant. These words are designed to drive the message that name-calling really isn't “cool”. When you ask students how they feel when someone called them such-and-such, most kids do not like it at all. Sometimes, the older the student become the less affected they say they are. “I don't care,” or “I'm used to it,” or “it doesn't bother me.” Yet, studies tell us that in the cases of school shootings, two factors underline the cases: (1) In 40 school shooting cases studied, the shootings were completed by boys, and (2) in a large number of those cases, cumulative incidents of teasing in school over years and years are said to have triggered the shootings.

The sticker reminds students that it is no longer acceptable to just be kidding because kidding is when both parties are laughing and having fun. It is no longer kidding when one party is laughing and the other party is humiliated. Too often the latter describes perfectly the interaction that occur in schools on a daily basis.

The sticker is most appropriate and understandable for students as young as first grade to older students in high school. It can be adhered to notebooks, pencil cases, book covers, mirrors, backpacks, journal books, or anywhere.

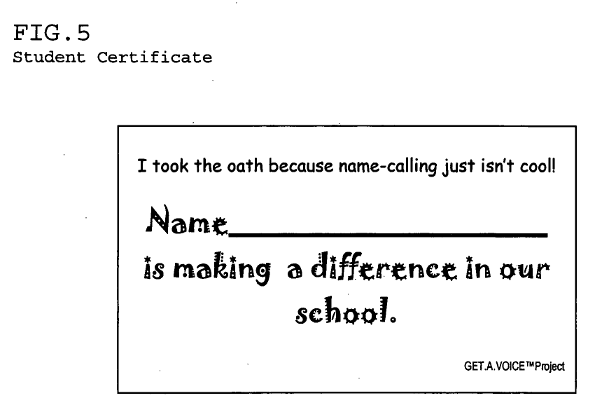

FIG. 5 illustrates the student certificate, which is provided to students after they take the oath. It is approximately 5″×7″ in size. It reads, “I took the oath because I think name-calling just isn't cool”. The student's name is written on the line on the certificate which serves to affirm the importance of the student's role in helping to stop name-calling. The certificate can then be displayed in the classroom on the wall or bulletin board designated for student participants, or the student can take it home to display it on the refrigerator or elsewhere at home. It is designed for the teacher and the parent to see the effort of the student and is intended to further deepen the commitment of the student to end name-calling.

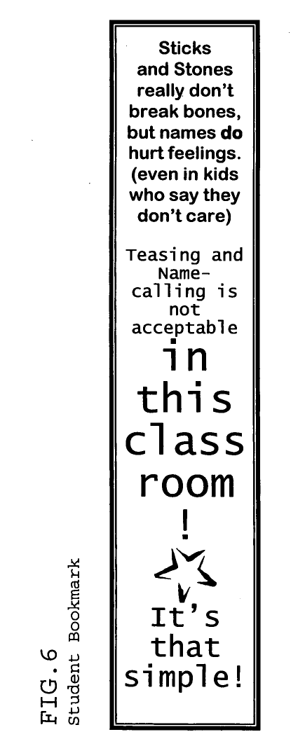

FIG. 6 illustrates the student bookmark, which is also provided to students after they take the oath. The bookmark is intentionally designed for students to use it as a bookmark. The notion of a bookmark is vital because students read everyday in school and thus it is always in view. It contains a statement, which challenges the 'sticks and stones' myth. It reads, “Sticks and stones really don't break bones, but names do hurt feelings (even in kids who say they don't care).” It further reads, “Teasing and Name-Calling is not acceptable in this classroom! It's that simple! Thank you for being a leader.”

The first statement is intentionally designed to give the message to students that, despite what they may think, name-calling hurts whether one is kidding or not. The second statement is designed to remind students that teasing and name-calling is just not acceptable in the parameters of that physical space. The third statement is designed to thank the student for being a leader for taking the oath and for practicing carrying out the steps of the program.

FIG. 7 illustrates the laminated card, which is provided to adults to display on their door. The laminated door card is visually colorful and contains the slogan, “If you're just kidding,just stop! This is a no-name-calling zone!” This is not only a slogan for the door; this is a slogan that becomes a mantra for teachers. It is said quickly and the words are powerful and true. The laminated door card serves three purposes: (a) it lets other adults and students know that inside that room is a teacher who is providing a space free from name-calling, hurtful, inappropriate, or offensive language; (b) it reminds individuals in school that name-calling is not acceptable and that they should stop; and (c) it visually portrays the wave-effect of those on board in the school.

There are, of course, variations to this method, which are envisioned to be within the scope of the present invention, such as the following:
One can copy and reproduce everything in the kit since it all the pieces of the kit are printed on paper.
One can vary the oath by calling it something else ( a pledge, a statement, a whatever).
One can create a computer interactive model that students can do no-line or in the classroom that simulates a shift in thinking process.
One can create a game that utilizes a decision-making model.
Including parents in the process-oath-taking parents.

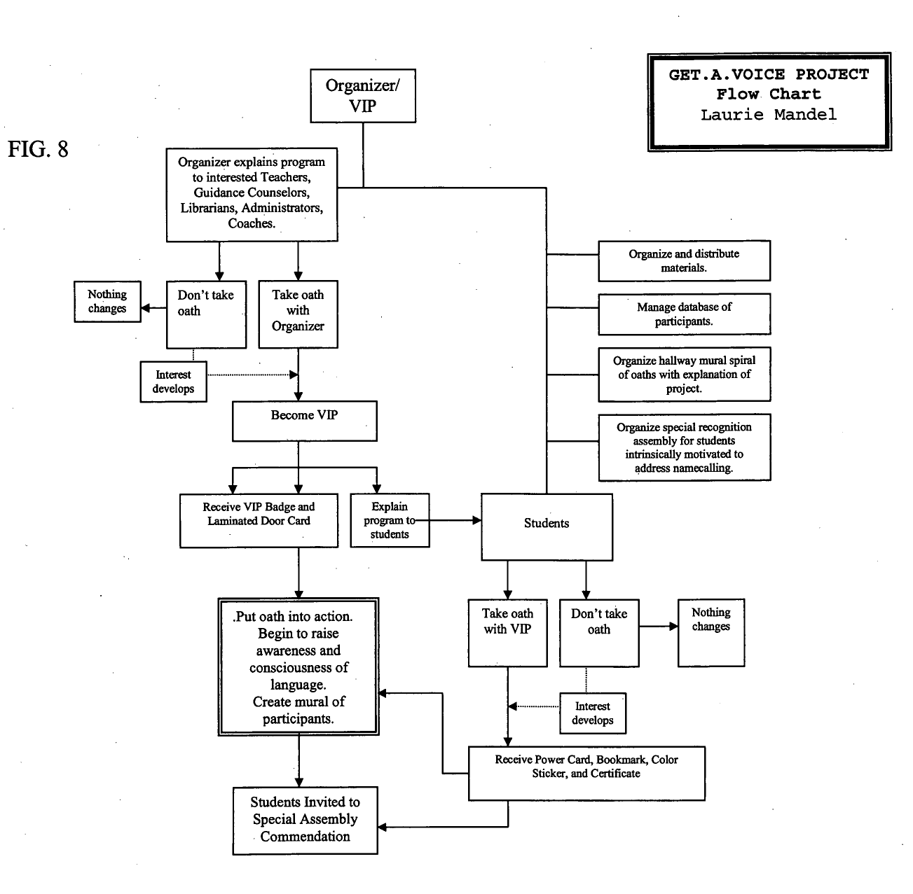

The following steps of the present invention accompany the flow chart shown in FIG. 8:
STEP 1 A faculty member within the school volunteers to coordinate the name-calling program in school. This person is the contact person who organizes the program in the school and distributes teacher kits to participating teachers.
STEP 2 After explaining the program to the interested adults, they take the oath out loud in the presence of the coordinator. Non-interested adults who do not participate in the program can choose to participate within a reasonable time frame at a later date.
STEP 3 Interested adults who take the oath become VIP's (Verbalists in Prevention) which allows them to explain the program to their students and implement the name-calling program with students.
STEP 4 Adults who take the oath receive two items: a VIP badge and a laminated card for their door.
STEP 5 Interested students who wish to participate take the oath out loud and then sign the oath card, date it, and then it is signed by the VIP. Non-interested students who do not participate in the program can choose to participate within a reasonable time at a later date.
STEP 6 Students who take the oath receive four items: a power card, bookmark, a sticker, and a certificate.
STEP 7 Students and adults put the oath into action through the use of the phrase on the power card. By doing so, students and adults begin to raise their own and other's awareness and consciousness of language. Students become a choir for the teacher by challenging each other when they hear inappropriate language. The dominant culture creates a more positive school environment. Thus, as students became conscious of their own language and other's language, a shift in their own thinking takes place.
STEP 8 A mural of all oath cards in created in public view in designated school hallway. A title and definition of the program goal are made to accompany the oaths.
STEP 9 A special assembly commendation is recommended in recognition of the students intrinsically motivated to participate in the program to end name-calling in schools.

Name-calling hurts. Despite what children often say, whether they are the target or a bystander, words have a tremendous impact on everyone in the school.

Not only do children really suffer form such language, but teachers know to well that stopping a lesson to address comments and name-calling is not only exhausting but time-consuming.

The GET.A.VOICE™ program was developed for administrators and teachers to help students become more aware of their own language and to develop a positive voice. In order to change the social culture, a “shift in thinking” needs to take place. The GET.a.voice™ program helps to literally shift one's thinking and raise consciousness.

### Further Unique Features of the Program

It is not another curriculum: The implementation neither takes a lot of time, not requires extensive training.

It is not mandatory: The program begins with a core group of interested faculty who then implement it with students in their classroom who want to make a difference.

It generates a “Wave Effect”: Students become a choir for the teacher, and positive leaders with/for each other. If effectively addresses the bystanders/observers, and other often want to become involved.

It helps adults tackle a problem with consistency: Teachers not only want to make stop, they want kids to “get it.” This program helps students to “get a ‘positive’ voice”, and brings consistency to adults who want to tackle this tough issue.

Although illustrative embodiments of the present invention have been described herein with reference to the accompanying drawings, it si to be understood that the invention is not limited to those precise embodiments, and the various other changes and modifications may be effected therein by one skilled in the art without departing from the scope of spirit of the invention.

It will be understood that each of the elements described above, or two or more together, may also find a useful application in other types of constructions differing from the types described above.

While the invention has been illustrated and described as embodied in a multi-function jewelry chain primarily for supporting an upper torso garment, it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The power card contains a list of ten effective one-line phrases. They are specifically one-liners so that students can remember them, recall them, and say them with ease. The heading on top of the card reads, “10 things I can say when I hear hurtful, inappropriate, or offensive language.” It is stated in this way so that students can easily remember that they have a reference tool with statements ready for them when needed. They are effective also in that if a student remembers one or two lines and draws upon those lines in every situation, the power card is just as effective. The language is child-friendly and child-tested.

The size of the card and the card-stock paper it is printed on is specific to this invention. As a reference tool, the 4″×6″ card can be taped inside the flap of a student's notebook or taped to the desk of a student at the elementary school level, and can be folded and placed in a wallet or pocket or inside the locker of a secondary school student who will most likely wish to keep it out of one's view. The cardstock is selected for its durability.

FIG. 3 illustrates the VIP badge, which is given to and worn by adults in the school community ( teachers, administrators, librarians, social workers, aids and the like) who have taken the oath. It is a small 2″×3″ badge which reads, “Take your oath with me, I'm a VIP.” It is printed on a bright orange paper and slid into a plastic pin-back name-badge. Adults pin the name-badge to their identification necklaces (usually required in schools).

The badge lets students know three important pieces of information: (a) that the teacher is an adult role model who also took the oath, (b) that the teacher does not tolerate name-calling, or hurtful, inappropriate, and offensive language, and (c) that the student can take the oath with that teacher when he/she is ready to do so. The badge also lets other adults know that their colleague is participating in this program to address name-calling.

FIG. 4 illustrates the stickers provided to students who take the oath. The full-color stickers contain the slogan created specifically for this program, which reads, “Just kidding? Just stop! Name-Calling Just Isn't Cool!” The sticker is approximately 1″×3″ and is colorful, small, and poignant. These words are designed to drive the message that name-calling really

The invention claimed is:

1. A Character Education method designed to address name calling in elementary and middle school comprising the steps of helping adults and students become aware of their own language and developing a positive voice.

2. A Character Education method design to address name calling in elementary and middle schools comprising the steps of (i) raising the awareness of adults and children about the language they use; (ii) teaching ways to intercept hurtful language; and (iii) empowering students to stand up and challenge others and the language others use in a kind and respectful way.
